(19) United States
(12) Patent Application Publication
(10) Pub. No.: US 2008/0138548 A1
(43) Pub. Date: Jun. 12, 2008

(54) ANNULAR OPTICAL LASER WELDING METHOD

(75) Inventor: Olivier SCIARA, Fontaine le Comte (FR)

Correspondence Address: SUGHRUE MION, PLLC, 2100 PENNSYLVANIA AVENUE, N.W., SUITE 800, WASHINGTON, DC, 20037, US

(73) Assignee: SAFT GROUPE SA, BAGNOLET (FR)

(21) Appl. No.: 11/950,551

(22) Filed: Dec. 5, 2007

(30) Foreign Application Priority Data
Dec. 8, 2006 (FR) 0610709

(51) Int. Cl. B32B 1/00; B23K 26/20

(52) U.S. Cl. 428/34.1; 219/121.64

(57) ABSTRACT

A welding method in the manufacture of an accumulator comprising a cover with a ball welded onto the periphery of an opening formed through the cover, comprises welding the ball onto the cover of the accumulator by placing the ball (1) in contact with the periphery of an opening (2) formed through a metal part (3, 11) preferably of aluminum, and then welding the ball, preferably of aluminum or steel, onto the periphery of the opening using a laser emitting a beam with an annular cross-section (4).

### FIELD OF THE INVENTION

The technical field of the invention is that of metal welding methods.

### BACKGROUND ART

The present invention relates to a welding method to seal the container of an accumulator.

A sealed accumulator or sealed electrochemical generator (as these two terms are equivalent, the term “accumulator” will be used in the present description) comprises, in a way that is known per se, an electrochemical bundle comprising alternating positive and negative electrodes framing separators. The electrochemical bundle is arranged in a container. It is impregnated with an electrolyte. The accumulator is sealed tight by a cover.

The cover generally comprises a wall comprising an opening (orifice) by means of which the accumulator can be filled with electrolyte. After filling, it is common to seal the accumulator by blocking the opening in the cover. This can be done by placing a stainless steel ball on this opening and welding it onto the opening by electric welding.

The wall of the cover can be made of aluminum. In this case, the welding of a stainless steel ball onto an aluminum wall using known welding methods does not produce good results. Moreover, the combination of aluminum with stainless steel is not recommended when these two metals are in contact with a common electrolyte. It is therefore preferred to use an aluminum ball which is welded onto the aluminum wall of the cover.

The known methods for welding a ball onto a wall of an accumulator cover do not make it possible to guarantee the sealing of the accumulator. In fact, it often happens that the ball moves at the time of welding. Because of this, it is no longer centered on the opening and the fluid-tightness of the weld is not of good quality. The repeatability of the welding method is also mediocre.

A method for welding a ball onto the wall of the cover of an accumulator which would make it possible to improve the fluid-tightness of the weld is therefore sought.

### SUMMARY OF THE INVENTION

For this purpose, the invention proposes a welding method comprising the steps consisting in:

a) placing a ball in contact with the periphery of an opening formed through a metal part,

b) welding the ball on the periphery of the opening using a laser emitting a beam with an annular cross-section.

According to one embodiment, the ball is made of aluminum.

According to another embodiment, the ball is made of stainless steel.

According to one embodiment, the metal part is made of aluminum.

According to a preferred embodiment, the ball is preformed by electric welding before the welding of step b).

According to a preferred embodiment, step b) is carried out at least twice.

According to a preferred embodiment, step b) is carried out twice.

The invention also provides a method for manufacturing an accumulator comprising a step of welding a ball onto a cover of an accumulator by the welding method described above. This method makes it possible to seal the accumulator.

According to one embodiment, the ball and the cover are made of aluminum and are in contact with an electrolyte.

Finally, the invention also provides an accumulator comprising a container and a cover with a ball welded on the periphery of an opening formed through the cover, the ball being able to be welded by the welding method described above.

The accumulator comprises a container and a cover with a ball welded on the periphery of an opening formed through the cover, the upper surface of the ball having a recess at its center and a bulge of circular shape.

### BRIEF DESCRIPTION OF THE DRAWINGS

FIG. 1 is a cross-sectional view of a ball resting on the periphery of an opening formed through the wall of a metal part before welding.

FIG. 2 is a schematic diagram of the firing of an annular optical laser beam onto a ball to be welded onto a metal part.

FIG. 3 is a longitudinal cross-sectional view of a ball preformed by electric welding on an orifice of a metal part.

FIG. 4 is a cross-sectional view of a ball welded onto the periphery of an opening formed through a metal part. The ball has been simply placed on the periphery of the opening before application of the laser firing.

FIG. 5 is a cross-sectional view of a ball welded on the periphery of an opening formed through the wall of a metal part. The ball has previously been forged by electric welding in order to assume the shape of the opening before application of the laser firing.

FIG. 6 is a longitudinal cross-sectional view of an accumulator whose cover comprises an orifice blocked by a ball, this ball having been welded on the orifice by the welding method according to the invention.

### DETAILED DESCRIPTION OF EMBODIMENTS

The steps of the welding method will now be described.

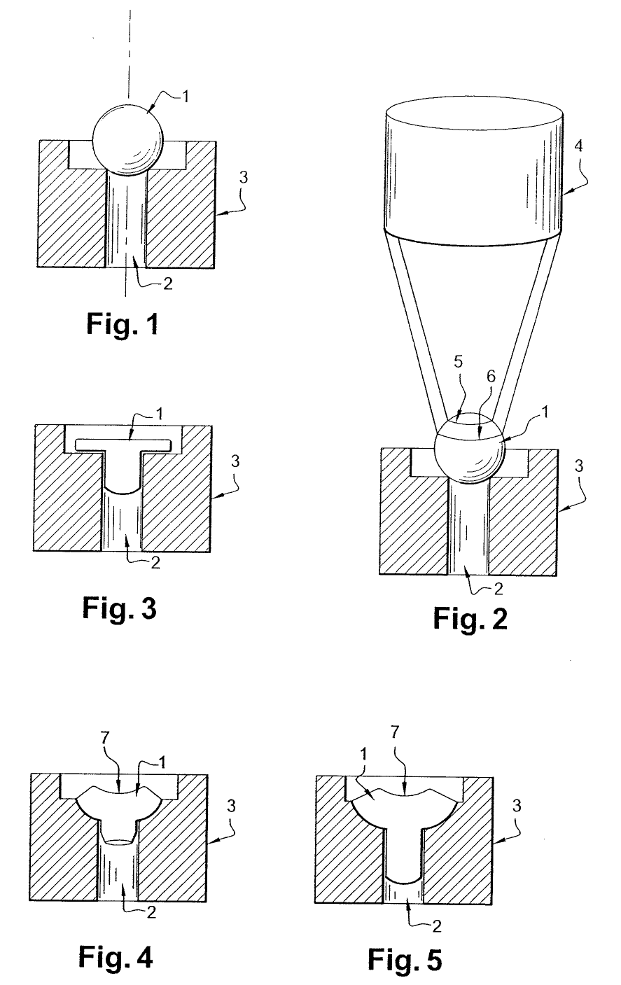

In a first step, the ball to be welded is placed in contact with the periphery of an opening formed through a metal part serving as a support. FIG. 1 shows the ball and the metal part in longitudinal cross-section. The ball 1 rests on the periphery of an opening 2 formed through the metal part serving as a support 3.

The material of the ball can for example be stainless steel or aluminum. The ball is preferably made of aluminum. It is for example possible to choose aluminum 1050 (purity greater than 99.5% aluminum).

The metal part serving as a support can be made of aluminum, for example aluminum 3003 (aluminum containing between 1 and 1.5% manganese and between 0.5 and 0.20% copper as alloy elements).

In a preferred embodiment, the ball and the metal part are made of aluminum.

The diameter of the ball does not have specific limits; it can for example be less than 2 mm. The diameter of the opening also has no specific limits: it can for example be less than 1.5 mm. Preferably, the diameter of the ball and the diameter of the opening will be chosen such that the ratio of the diameter of the ball to the diameter of the opening is between 1.1 and 2.2.

In a second step, at least one annular optical laser beam firing is carried out. The laser beam is called annular because the projection on a plane of the surface of the ball irradiated by the laser beam has the shape of a ring. FIG. 2 is a schematic diagram of an annular optical laser beam 4 firing onto a ball 1 that has to be welded on a metal part 3. The surface comprised between the inner diameter 5 and the outer diameter 6 of the ring corresponds to the surface irradiated by the laser beam.

The invention is based on the discovery that the use of an annular optical laser beam prevents the movement of the ball on the opening. In fact, in a firing of an annular optical laser beam, no energy is applied to the center of the ball. Because of this, the ball is not driven from its location; it can be welded onto the opening without risk of being moved.

Preferably, the welding step comprises at least two laser firings. They can be carried out at a frequency of 2.8 Hz (2.8 firings per second). The repetition of the laser firings makes it possible to improve the quality of the weld.

Preferably, the laser is of the Nd:YAG type. It will for example be possible to use a TRUMPF 304P (pulsed 300 W) laser having an optical fiber of diameter 400 μm or more if necessary: 600 or 1000 μm. The protective gas is in this case argon, for example. Other inert gases can be used: helium, nitrogen of a mixture constituted by these different gases, flowing at a rate of 10 L/min for example. The focal length is fixed, for example at 100 mm. The optics are annular optics.

The firing power must be adapted to the dimensions of the ball to be welded. When the latter has a diameter of about 1.5 mm, the peak power is about 6 kW and the duration of the laser firing is about 12 ms. The energy delivered is about 72 J. The mean power is 72 W with one firing and 201 W for two successive firings at a frequency of 2.8 Hz.

It is possible to vary the defocusing in order to vary the width of the laser beam. The laser beam must be sufficiently wide to obtain a weld of sufficient solidity.

According to one embodiment, the defocusing is by +4 mm. The defocusing serves to adjust the width of the welding ring in the focal plane.

Preferably, the ball is preformed by electric welding before the annular optical laser welding step. The preforming consists of subjecting the ball to a pressure and in applying an electric current through it in such a way as to deform it and to cause its partial insertion into the opening. The preforming corresponds to hot forging. FIG. 3 is a longitudinal cross-sectional view of a preformed ball 1 in an opening 2 of a metal part serving as a support. The preforming by electric welding before the laser welding step makes it possible to modify the shape of the ball so that it closely fits the shape of the opening. The preforming therefore makes it possible to stabilize the position of the ball before welding and to improve the fluid-tightness of the weld and the repeatability of the welding method. This advantage is revealed on comparing FIG. 5 with FIG. 4. In these two figures, the longitudinal cross-section of the opening 2 is T-shaped. The vertical stem and the horizontal branch of the T correspond to two cross-sections of the opening of different diameters, The ball shown in FIG. 4 has been welded without preforming on the opening whilst the ball shown in FIG. 5 has been preformed in a preliminary preforming step. It is observed that the contact area between the ball and the opening is much smaller in FIG. 4 than in FIG. 5, whether this be in the horizontal branch of the T or in its vertical stem. The ball shown in FIG. 5 fits perfectly with the contour of the opening. This is an advantage when it is required to seal a container containing products presenting a risk to the environment and to persons nearby.

The method according to the invention makes it possible to seal the container at the weld (allowed leakage less than 10⁻⁷ cm³/s under a helium pressure of 1 bar).

In a particularly preferred embodiment, the ball is preformed by electric welding and then two successive firings of the annular optical laser beam are carried out.

The ball welded by the method according to the invention has a characteristic shape. The upper surface of the ball in fact exhibits a recess 7 at its center and a bulge of circular shape situated on the surface of the ball irradiated by the laser beam. This bulge is due to the expansion of the metal of the ball under the effect of the heat release produced by the impact of the laser beam. The central part of the ball is not deformed because is does not receive the heat of the laser beam. This deformation is characteristic of a weld produced using an annular optical laser. It is not obtained in a conventional electric welding method, nor in conventional laser welding.

The method according to the invention is used for closing an accumulator in a fluid-tight manner. Up until the present time, the methods for welding a ball onto an accumulator cover have not produced satisfactory results. The annular optical laser welding method makes it possible to obtain a weld exhibiting satisfactory fluid-tightness.

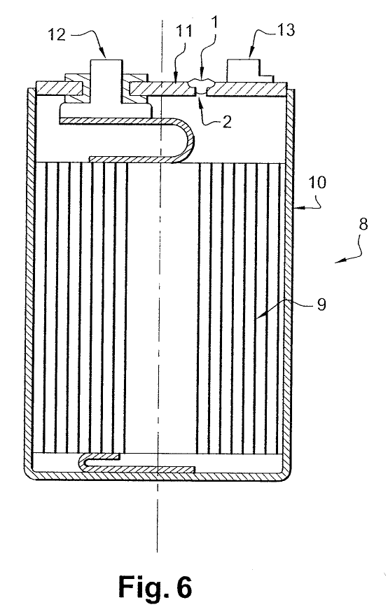

Reference is made to FIG. 6 which is a longitudinal cross-sectional view of an accumulator 8 the cover 11 of which comprises an orifice blocked by a ball 1 according to the method of the invention.

Conventionally, the electrochemical bundle 9 is inserted into a container 10. A cover 11 is placed on the open end of this container. This cover can support one or two output current terminals 12 and 13. It is also provided with an opening (or orifice) 2 by means of which an electrolyte is introduced into the container. Once the container of the accumulator is full, a ball is placed on the orifice in order to block it. The accumulator is sealed tight by welding the ball onto the orifice using the method according to the invention. One of the advantages of the method according to the invention is that it is possible to produce a weld of an aluminum ball on a cover of the accumulator made of aluminum even if the electrolyte is in contact with the inside surface of the cover and the aluminum ball.

For an alkaline accumulator, the electrolyte is a concentrated alkaline aqueous solution comprising at least one hydroxide (KOH, NaOH, LiOH), at a concentration generally of the order of several times normality.

For a lithium ion accumulator, the solvent is an organic solvent in which a lithium salt is dissolved. The organic solvent can be chosen from the group of cyclic carbonates, linear carbonates or linear esters or a mixture of the latter. The salt used is a lithium salt that can be chosen from the following salts: LiPF₆, LiBF₄, LiBOB (lithium bis-oxalatoborate), LiBETI (lithium bis(perfluoroethylsulfonylimide)) or a mixture of the latter.

In a preferred manner, the periphery of the filling orifice is cleaned before welding in order to remove traces of electrolyte.

In a preferred manner, two successive welding operations are carried out. A frequency of 2.8 Hz is considered sufficient.

The method according to the invention can be applied for blocking off a primary or secondary electrochemical generator. The format of the container can be prismatic (flat electrodes) or cylindrical (spiral electrodes) or concentric (coil). The method is well suited to lithium-ion accumulators.

The welding method makes it possible to seal the accumulator at the weld. Fluid-tightness in the helium test is obtained because the tests indicate a leakage less than 10⁻⁷ cm³/s under a helium pressure of 1 bar.

1-11. (canceled)

12. A welding method comprising the steps of:
a) placing a ball in contact with the periphery of an opening formed through a metal part,
b) welding the ball onto the periphery of the opening using a laser emitting a beam with an annular cross-section.

13. The method according to claim 12, wherein the ball is made of aluminum.

14. The method according to claim 12, wherein the ball is made of stainless steel.

15. The method according to claim 12 wherein the metal part is made of aluminum.

16. The method according to claim 13 wherein the metal part is made of aluminum.

17. The method according to claim 14 wherein the metal part is made of aluminum.

18. The method according to claim 12 wherein the ball is preformed by electric welding before the welding of step b).

19. The method according to claim 12, wherein step b) is carried out at least twice.

20. The method according to claim 19, wherein step b) is carried out twice.

21. A method for manufacturing an accumulator comprising a step of welding a ball onto a cover of an accumulator by a welding method comprising the steps of:
a) placing the ball in contact with the periphery of an opening formed through a metal part,
b) welding the ball onto the periphery of the opening using a laser emitting a beam with an annular cross-section.

22. The method according to claim 21, wherein the ball and the cover are made of aluminum and are in contact with an electrolyte.

23. An accumulator comprising a container and a cover with a ball welded onto a periphery of an opening formed through the cover, the ball being able to be welded by a welding method comprising the steps of:
a) placing the ball in contact with the periphery of an opening formed through a metal part,
b) welding the ball onto the periphery of the opening using a laser emitting a beam with an annular cross-section.

24. An accumulator comprising a container and a cover with a ball welded onto a periphery of an opening formed through the cover, an upper surface of the ball having a recess at its center and a bulge of circular shape.
